(19) United States
(12) Patent Application Publication
(10) Pub. No.: US 2014/0362718 A1
(43) Pub. Date: Dec. 11, 2014

(54) COMMUNICATION TERMINAL DEVICE, COMMUNICATION SYSTEM, COMMUNICATION STATE DISPLAY METHOD, AND COMPUTER-READABLE RECORDING MEDIUM

(71) Applicants: Shoh Nagamine, Kanagawa (JP); Takahiro Asai, Kanagawa (JP); Takuya Imai, Tokyo (JP)

(72) Inventors: Shoh Nagamine, Kanagawa (JP); Takahiro Asai, Kanagawa (JP); Takuya Imai, Tokyo (JP)

(21) Appl. No.: 14/366,109

(22) PCT Filed: Dec. 27, 2012
(86) PCT No.: PCT/JP2012/084293

§ 371 Date: Jun. 17, 2014

(30) Foreign Application Priority Data
Dec. 28, 2011 (JP) 2011-287121
Nov. 9, 2012 (JP) 2012-247013

(51) Int. Cl. H04L 12/26

(52) U.S. Cl. CPC H04L 43/045; H04L 43/0894; H04L 43/16
USPC 370/252

(57) ABSTRACT

A communication terminal device performs communication with another communication terminal device through a network. The communication terminal device includes a storage unit configured to store therein thresholds for communication speed and display methods for displaying states of the communication speed for respective groups into which communication quality is categorized; an acquiring unit configured to acquire a communication speed during communication; a determining unit configured to compare the acquired communication speed with the thresholds for the communication speed stored in the storage unit and determine a display method for displaying a state of the acquired communication speed; and a display unit configured to display the state of the acquired communication speed with the determined display method.

### TECHNICAL FIELD

The present invention relates to a technique of displaying a communication state on a communication terminal device in a network communication system in which users communicate with each other using respective communication terminal devices through a network.

### BACKGROUND ART

Recently, with the larger capacity of a network, the application of the network communication system in which users communicate with each other while looking at expressions on their faces through a network, which is represented by a video conference system and a web conference system, is increasing.

In the communication system using a network, video, audio, and other data are transmitted and received between communication terminal devices, and the quality thereof generally depends on a network environment used for communication. For example, in the video conference system or web conference system using a general internet line or a wireless network, there often occurs a phenomenon such that a communication band of video, audio, etc., in the network becomes narrow, and the decrease of a communication speed significantly deteriorates the quality of video, audio, etc. in a conference.

Then, conventionally, the technique of displaying values of the communication speed of transmission and reception of video, audio, etc. during communication on a user terminal is considered as one of means allowing a user to recognize the state of a network environment during communication such as a video conference, and already known. However, as the video quality significantly varies depending on whether the communication quality is standard definition (SD) image quality or high definition (HD), image quality even if the communication speed of the video is 500 kbps in both of the cases, for example, a numeral itself of the communication speed does not represent the absolute quality of video, audio, etc. Thus, there is a problem that it is not easy for a general user to understand, from values of the communication speed, whether the quality of video and audio sufficient for performing a conference (communication) can be maintained at such a value.

Cisco Unified Video Advantage Video Telephony Solution <http://www.cisco.com/web/JP/product/hs/iptel/vta/prodlit/vtadv_ds.html> describes that the quality of images received and transmitted during a conference is displayed graphically. However, this only allows a user to recognize the quality of transmitted and received images, and it is not easy for the user to understand even the condition and state of the communication speed of transmission and reception of video, audio, etc. during a conference (communication).

Therefore, there is a need to allow a general user, when users communicate with each other using respective communication terminal devices through a network, to easily understand whether the quality sufficient for performing communication (communication quality) can be maintained at a communication speed of transmission and reception of video, audio, etc. during communication.

### DISCLOSURE OF INVENTION

It is an object of the present invention to at least partially solve the problems in the conventional technology.

According to an embodiment, there is provided a communication terminal device that performs communication with another communication terminal device through a network. The communication terminal device includes a storage unit configured to store therein thresholds for communication speed and display methods for displaying states of the communication speed for respective groups into which communication quality is categorized; an acquiring unit configured to acquire a communication speed during communication; a determining unit configured to compare the acquired communication speed with the thresholds for the communication speed stored in the storage unit and determine a display method for displaying a state of the acquired communication speed; and a display unit configured to display the state of the acquired communication speed with the determined display method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF DRAWINGS

FIG. 1 is a schematic configuration diagram of a communication system according to an embodiment of the invention;

FIG. 2 is an external view of a communication terminal device according to the embodiment;

FIG. 3 is a hardware configuration of the communication terminal device according to the embodiment;

FIG. 4 is a specific function block diagram of a communication terminal device according to a first embodiment;

FIG. 5 is a process flowchart of the communication terminal device according to the first embodiment;

FIG. 6 is a diagram illustrating concrete communication speeds to be acquired;

FIG. 7 is a diagram illustrating a concrete example of thresholds and display methods of the communication speed in a first embodiment;

FIG. 8 is a diagram illustrating another concrete example of thresholds and display methods of the communication speed in the first embodiment;

FIG. 9 is a diagram illustrating display examples of the state of a communication speed during communication in the first embodiment;

FIG. 10 is a diagram illustrating alternative display examples of the state of a communication speed during communication in the first embodiment;

FIG. 11 is a specific function block diagram of a communication terminal device according to a second embodiment;

FIG. 12 is a process flowchart of the communication terminal device according to the second embodiment;

FIG. 13 is a diagram illustrating a concrete example of thresholds and display methods of the communication speed in the second embodiment;

FIG. 14 is a diagram illustrating a concrete example of thresholds and display methods of a virtual theoretical value of the second embodiment;

FIG. 15 is a diagram illustrating a display example of the states of a communication speed and a virtual theoretical value during communication in the second embodiment; and

FIG. 16 is a diagram illustrating another display example of the states of a communication speed and a virtual theoretical value during communication in the second embodiment.

### BEST MODE(S) FOR CARRYING OUT THE INVENTION

In the following, embodiments of the invention will be described with reference to the enclosed drawings.

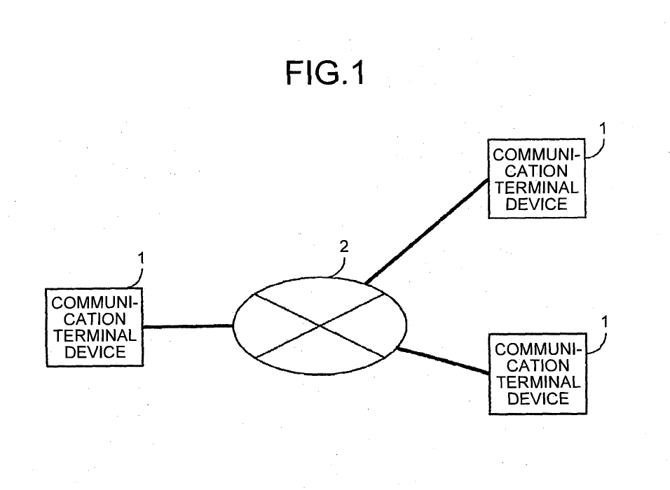

FIG. 1 is a schematic configuration diagram of a communication system according to an embodiment of the invention. The communication system includes a plurality of communication terminal devices 1, and a network 2 to which the communication terminal devices 1 are connected. As described later, each of the communication terminal devices 1 has a camera, a microphone, a speaker, and a display (display device). The network 2 may be a dedicated line or an internet line. A server device shared by the communication terminal devices may be connected to the network 2, although it is omitted in FIG. 1.

A plurality of users perform communication such as a video conference, using the respective communication terminal devices 1 through the network 2. Then, video, audio, and data such as a document are transmitted and received between the communication terminal devices 1. The quality of such video, audio, etc. depends on a network environment used for communication. Thus, when a communication band used in the network 2 becomes narrow, and the communication speed of transmission and reception of video, audio, etc. is decreased, the quality of such video, audio, etc. is deteriorated. Here, the quality of video, audio, etc. during communication is referred to as communication quality in communication.

In the communication terminal device 1, the communication quality in communication is categorized into a plurality of groups and, for each of the groups, a threshold for communication speed and a display method for displaying the state of the communication speed are preliminarily stored, as described later. Then, when communication such as a video conference is performed through the network 2, the communication terminal device 1 acquires a communication speed during communication, compares the acquired communication speed with stored thresholds for the communication speed, and thus determines a display method for displaying the state of the communication speed during communication so as to display the state of the communication speed during communication with the determined method. For example, when a communication speed during communication is in a range (group) where the communication quality in communication is sufficiently satisfactory, the communication speed is displayed in green. When a communication speed during communication is in a range (group) where the communication quality in communication is not satisfactory, the communication speed is displayed in red. In this manner, a user can understand instinctively whether the communication quality sufficient for performing communication, that is, the sufficient quality of video, audio, etc. can be maintained at a communication speed during communication.

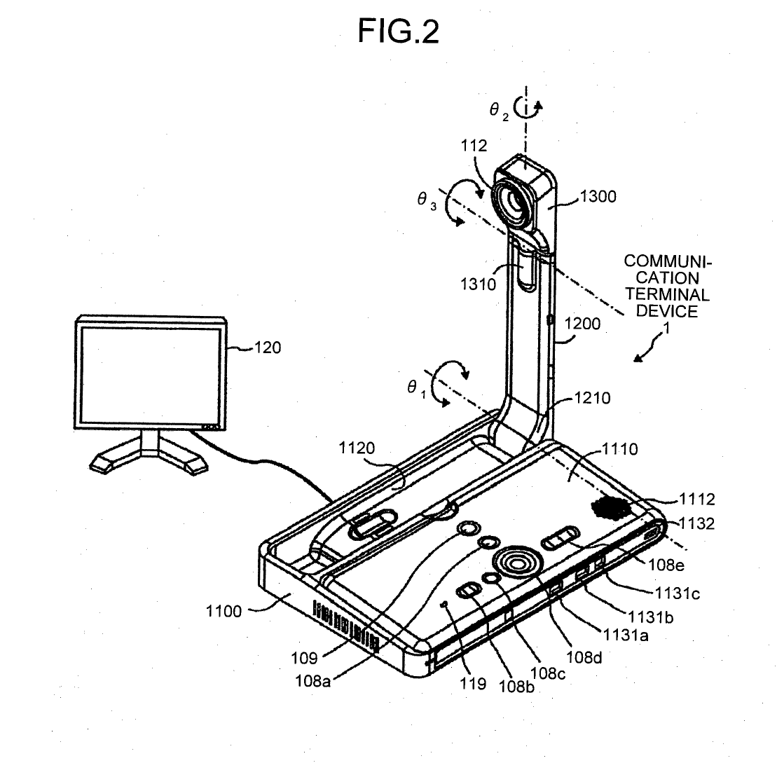

FIG. 2 is an external view of an embodiment of the communication terminal device 1. A general personal computer or other terminal devices may be used as the communication terminal device 1, as long as a camera, a microphone, a speaker, etc. are provided thereto.

In FIG. 2, the communication terminal device 1 has a housing 1100, an arm 1200, and a camera housing 1300. The housing 1100 houses therein a central processing unit (CPU), a memory, a circuit board having various electronic components, a microphone, a speaker, etc.

An operation panel 1110 is formed on the front upper face of the housing 1100 to which panel various operation buttons 108a to 108e, a power supply switch 109, an alarm lamp 119, etc. are provided. A number of audio output holes 1112 for an embedded speaker are also provided on the operation panel 1110. A concave housing portion 1120 for housing the arm 1200 and the camera housing 1300 is formed on the back upper face of the housing 1100.

A plurality of connection openings 1131a to 1131c for connection of external devices are provided on the front face of the housing 1100, and an audio acquisition hole 1132 for an embedded microphone is also provided thereon. Connection openings (not illustrated) for connection of external devices are provided also on the rear face of the housing 1100, and a display (display device) 120 is connected to one of the connection openings through a cable.

The arm 1200 is attached to the housing 1100 through a first torque hinge 1210, and configured so as to rotate upward and downward in a range of a tilt angle θ₁ of 0° to about 135°. FIG. 2 illustrates the state in which the tilt angle θ₁ is about 90°. When the tilt angle θ₁ is 0°, the arm 1200 and the camera housing 1300 are housed in the housing portion 1120 of the housing 1100.

The camera housing 1300 is provided with a camera 112. The camera housing 1300 is attached to the arm 1200 through a second torque hinge 1310, and configured so as to rotate upward, downward, leftward and rightward in a range of a pan angle θ₂ of ±180° and a range of a tilt angle θ₃ of ±45°. Therefore, the camera 112 is also rotated upward, downward, leftward and rightward to capture images of a user, a document, a room, etc.

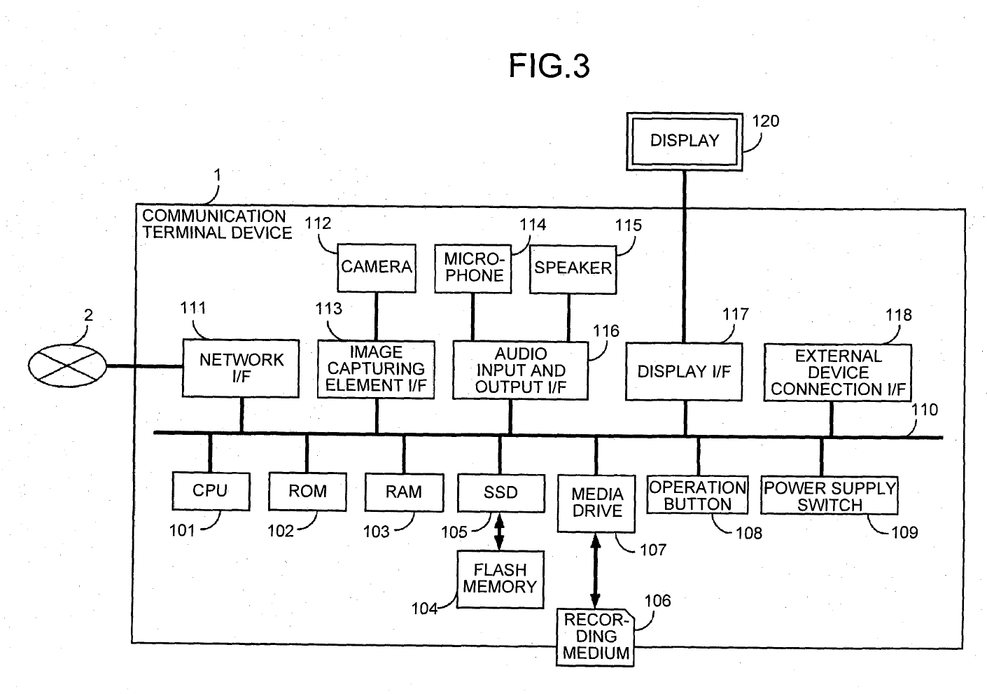

FIG. 3 is a hardware configuration example of the communication terminal device 1 according to the embodiment. The communication terminal device 1 has a CPU 101 controlling the action of the entire terminal device and performing necessary processing, a read only memory (ROM) 102 storing therein a program such as an initial program loader (IPL) that is used for driving the CPU 101, a random access memory (RAM) 103 used as a work memory of the CPU 101, a flash memory 104 storing therein the program executed by the CPU 101, video, audio, other various kinds of data, etc., a solid state drive (SSD) 105 controlling the reading and writing of the program and various kinds of data, etc. on the flash memory 104 in accordance with the control of the CPU 101, a media drive 107 controlling the reading and writing of data, etc. on an external recording medium 106, various operation buttons 108 (general term for 108a to 108e in FIG. 2), the power supply switch 109, various interfaces (I/F) 111, 113, 116, 117, and 118, and an internal bus 110 connecting these units.

The communication terminal device 1 further has therein the camera 112, a microphone 114 and a speaker 115, and the display (display device) 120 is provided externally thereto. The display 120 may be configured integrally with the communication terminal device 1.

The camera 112 is connected to the image capturing element I/F 113, and the microphone 114 and the speaker 115 are connected to the audio input and output I/F 116. The display 120 is connected to the display I/F 117. If necessary, various external devices are connected to the external device connection I/F 118 through the connection openings 1131a to 1131c in FIG. 2, etc. The network 2 is connected to the network I/F 111.

A program executed by the CPU 101 may be stored not in the flash memory 104 but in the ROM 102. A hard disk (HDD), etc. may be provided instead of the flash memory 104.

When communication such as a video conference is performed, video (video data) of a user, a document, etc. captured by the camera 112 are transmitted to the network 2 through the image capturing element I/F 113 and the network I/F 111, and displayed on the display 120 through the display I/F 117 at the same time. Audio (audio signals) of a user collected by the microphone 114 is transmitted to the network 2 through the audio input and output I/F 116 and the network I/F 111. Video (video data) received from the network 2 is displayed on the display 120 through the network I/F 111 and the display I/F 117. Audio (Audio signals) received from the network 2 is output to the speaker 115 through the same network I/F 111 and the audio input and output I/F 116.

The CPU 101 controls the action of the network I/F 111, the image capturing element I/F 113, the audio input and output I/F 116, the display I/F 117, etc. and controls various kinds of processing such as compression, decompression, etc. on video and audio that are transmitted and received through the network I/F 111. The processing of compression, expansion, etc. may be performed using a dedicated circuit, separately from the CPU 101.

The CPU 101 monitors a communication speed of video, audio, etc. during communication that are transmitted and received through the network I/F 111, and determines whether the communication quality allowing communication in a satisfactory manner, that is, the sufficient quality of video, audio, etc. can be maintained at the state of such a communication speed. Then, the CPU 101 determines a display method for displaying the state of the communication speed, and displays, using the determined method, the state of the communication speed during communication on the display 120 through the display I/F 117.

In the following, the configurations of the communication terminal device and the action thereof according to a first embodiment and a second embodiment of the invention are described in detail.

### First Embodiment

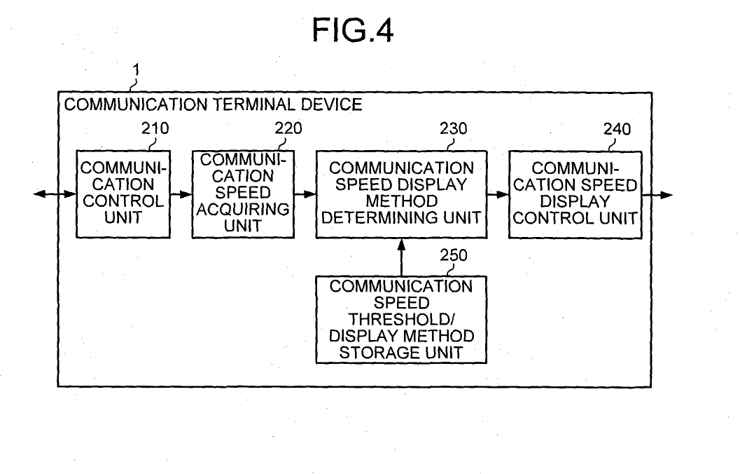

FIG. 4 illustrates a function block diagram of a main configuration of the communication terminal device according to the first embodiment. In FIG. 4, the communication terminal device 1 has a communication control unit 210, a communication speed acquiring unit 220, a communication speed display method determining unit 230, a communication speed display control unit 240, and a communication speed threshold/display method storage unit 250. Here, the communication control unit 210 corresponds to the network I/F 111 in FIG. 3. The functions of the communication speed acquiring unit 220, the communication speed display method determining unit 230, and the communication speed display control unit 240 are achieved in cooperation with the CPU 101 and a given program stored in the ROM 102 or the flash memory 104 in FIG. 3. The communication speed threshold/display method storage unit 250 corresponds to a given storage area in the flash memory 104 in FIG. 3.

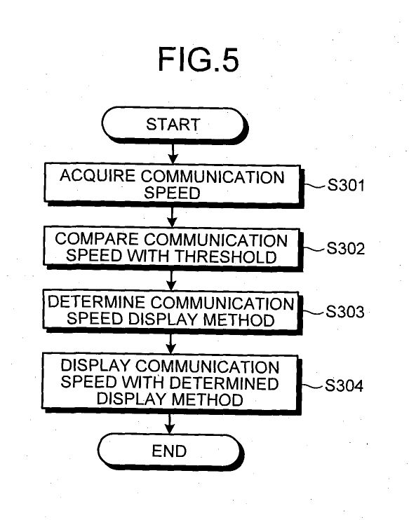

FIG. 5 illustrates a flow chart of the entire processing of the communication speed acquiring unit 220, the communication speed display method determining unit 230 and the communication speed display control unit 240 in FIG. 4. A program for performing the process flowchart is stored in the ROM 102 or the flash memory 104 in FIG. 3, as described above. The program may be recorded in a computer readable recording medium (external recording medium 106, etc.) for distribution.

FIG. 5 is also a diagram illustrating process steps of a communication state display method according to the first embodiment.

While a plurality of users perform, using the respective communication terminal devices 1, communication such as a video conference through the network 2, the communication control unit 210 (network I/F 111 in FIG. 3) of the communication terminal device 1 controls the transmission and reception of video, audio, etc. to and from other communication terminal devices. Thus, the communication control unit 210 controls the communication speed of transmission and reception of video, audio, etc.

While communication such as a video conference is performed through the network 2, the communication speed acquiring unit 220 acquires a communication speed of video, audio, etc. from the communication control unit 210 (Step S301). Then, the communication speed acquiring unit 220 transmits the acquired communication speed to the communication speed display method determining unit 230. The configuration is such that a communication speed is acquired automatically when the communication terminal device 1 is activated, or when a user sends an instruction, for example.

The communication speed threshold/display method storage unit 250 stores therein a threshold for the communication speed corresponding to the communication quality and a display method for displaying the state of the communication speed for respective groups into which the communication quality in communication is preliminarily categorized. The specific configuration of the communication speed threshold/display method storage unit 250 is described later.

During communication, the communication speed display method determining unit 230 compares the communication speed transmitted from the communication speed acquiring unit 220 with the thresholds for the communication speed in the communication speed threshold/display method storage unit 250 so as to determine which group the communication speed during the communication belongs to (Step S302) and determine a display method for displaying the state of the communication speed during the communication (Step S303). Then, the communication speed display method determining unit 230 notifies the communication speed display control unit 240 of the determined display method.

The communication speed display control unit 240 controls the display on the display 120 through the display I/F 117 in order to display the state of the communication speed during communication in accordance with the display method notified from the communication speed display method determining unit 230 (Step S304).

Next, the concrete action of the communication speed acquiring unit 220, the communication speed display method determining unit 230, and the communication speed display control unit 240 are described together with the concrete configuration of the communication speed threshold/display method storage unit 250.

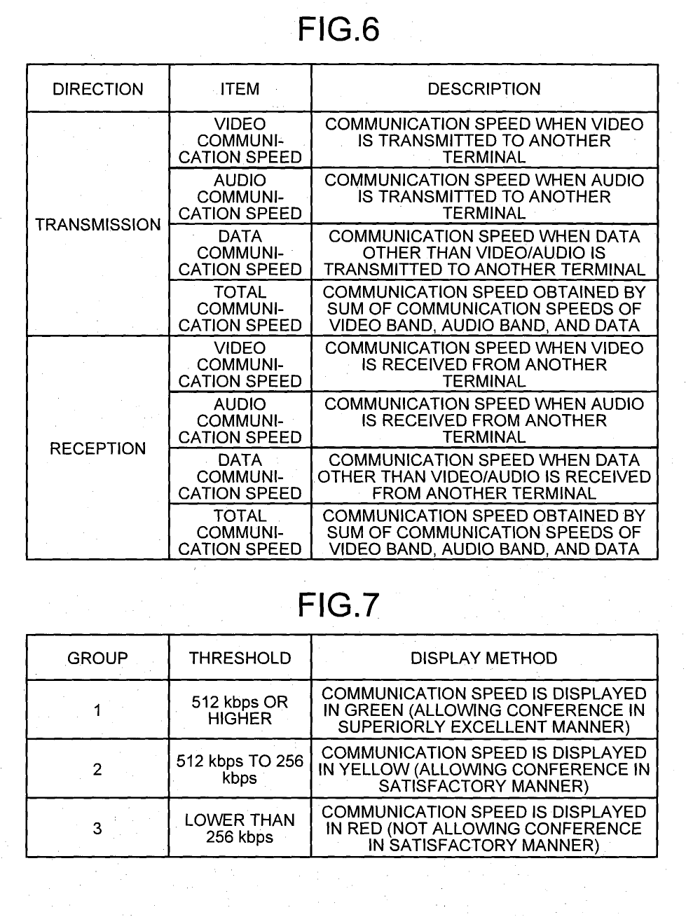

FIG. 6 is a diagram illustrating concrete communication speeds involved in the first embodiment. As illustrated in FIG. 6, the involved communication speeds include communication speeds at which a communication terminal device transmits video, audio, and other data to another communication terminal device, and communication speeds at which a communication terminal device receives video, audio, and other data from another communication terminal device.

In FIG. 4, the communication speed acquiring unit 220 acquires, from the communication control unit 210 (concretely, the network I/F 111 in FIG. 3), communication speeds at which the communication terminal device 1 transmits video, audio, data, etc. to another communication terminal device, and sums these communication speeds to obtain a transmission communication speed. Similarly, the communication speed acquiring unit 220 acquires, from the communication control unit 210, communication speeds at which the communication terminal device 1 receives video, audio, data etc. from another communication terminal device, and sums these communication speeds to obtain a reception communication speed. The communication speed acquiring unit 220 transmits the transmission communication speed and the reception communication speed to the communication speed display method determining unit 230.

When the communication control unit 210 controls the total transmission communication speed and reception communication speed of video, audio, data, etc., the communication speed acquiring unit 220 may acquire the total transmission communication speed and reception communication speed directly from the communication control unit 210.

FIG. 7 is a diagram illustrating a concrete example of thresholds and display methods of the communication speed stored in the communication speed threshold/display method storage unit 250. In the example of FIG. 7, the quality of communication (conference) is categorized into three groups, and the threshold for the corresponding communication speeds is also categorized into three groups, so that the state of the communication speed of each group is distinguished using a different color. In general, the number of groups may be two or a given number more than two.

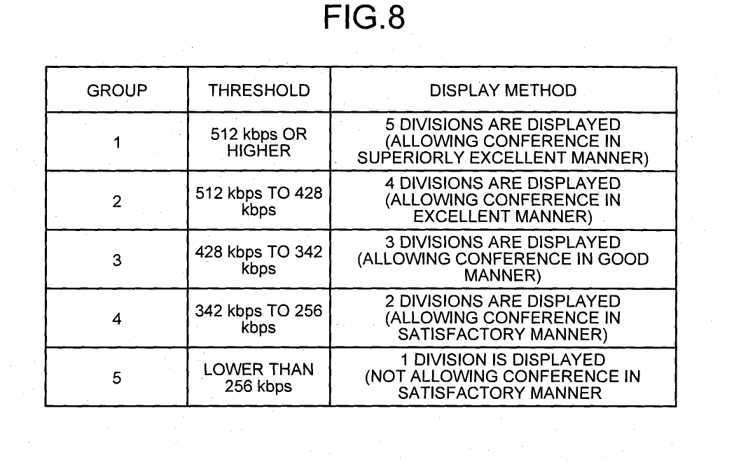

FIG. 8 is a diagram illustrating another concrete example of thresholds and display methods of the communication speed stored in the same communication speed threshold/display method storage unit 250. In the example of FIG. 8, the quality of communication (conference) is categorized into five groups, and the threshold for the corresponding communication speeds is also categorized into five groups, so that the state of the communication speed of each group is distinguished using the number of divisions. Also in this case, in general, the number of groups may be two or a given number more than two.

The communication speed display method determining unit 230 compares the communication speed (transmission communication speed and reception communication speed) transmitted from the communication speed acquiring unit 220 with the thresholds for the communication speed in the communication speed threshold/display method storage unit 250 so as to determine which group the communication speed belongs to, and determine a display method thereof. As a concrete example here, the transmission communication speed is 300 kbps, and the reception communication speed is 200 kbps.

In the example of FIG. 7, referring to the communication speed threshold/display method storage unit 250, the communication speed display method determining unit 230 determines that the transmission communication speed 300 kbps belongs to group 2 and the display method thereof is in yellow. Similarly, the communication speed display method determining unit 230 determines that the reception communication speed 200 kbps belongs to group 1 and the display method thereof is in red.

In the example of FIG. 8, referring to the communication speed threshold/display method storage unit 250, the communication speed display method determining unit 230 determines that the transmission communication speed 300 kbps belongs to group 4 and the display method thereof is with two divisions. Similarly, the communication speed display method determining unit 230 determines that the reception communication speed 200 kbps belongs to group 5 and the display method thereof is with one division.

The communication speed display control unit 240 controls the display on the display 120 through the display I/F 117 in order to display the state of the communication speed (transmission communication speed and reception communication speed) during communication using the display method determined by the communication speed display method determining unit 230.

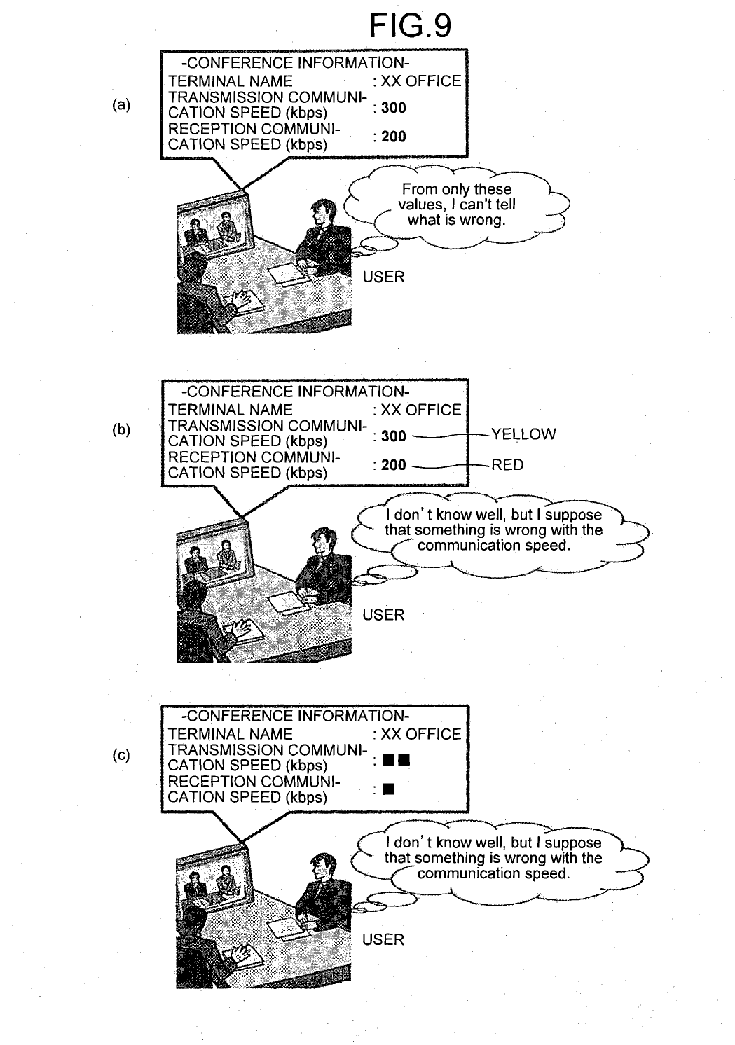

FIG. 9 is a diagram illustrating display examples on the display 120. Illustrated in (a) of FIG. 9 is a conventional display example, in which the values “300”, “200” of the transmission communication speed 300 kbps and the reception communication speed 200 kbps, respectively, are displayed as they are. In this case, when disturbances occur in video and audio during communication such as a video conference, a general user cannot tell, from only the values, what is wrong.

Illustrated in (b) of FIG. 9 is a display example with the display method of FIG. 7 applied, in which the value “300” of the transmission communication speed 300 kbps is displayed in yellow, and the value “200” of the reception communication speed 200 kbps is displayed in red. Illustrated in (c) of FIG. 9 is a display example with the display method of FIG. 8 applied, in which the transmission communication speed 300 kbps is displayed with two divisions, and the reception communication speed 200 kbps is displayed with one division.

In the cases of (b) and (c) of FIG. 9, when disturbances occur in video and audio during communication, a general user can instinctively understand, looking at the display, whether the communication speed allows him or her to hold a conference in a satisfactory manner, although the user cannot tell the exact grounds of the disturbances.

The display method of the state of the communication speed is not limited to the examples of (b) and (c) of FIG. 9. For example, in addition to color distinction or the number of divisions, various display methods such as the use of characters (words) or diagrams and the combination of a plurality of kinds of display can be applied.

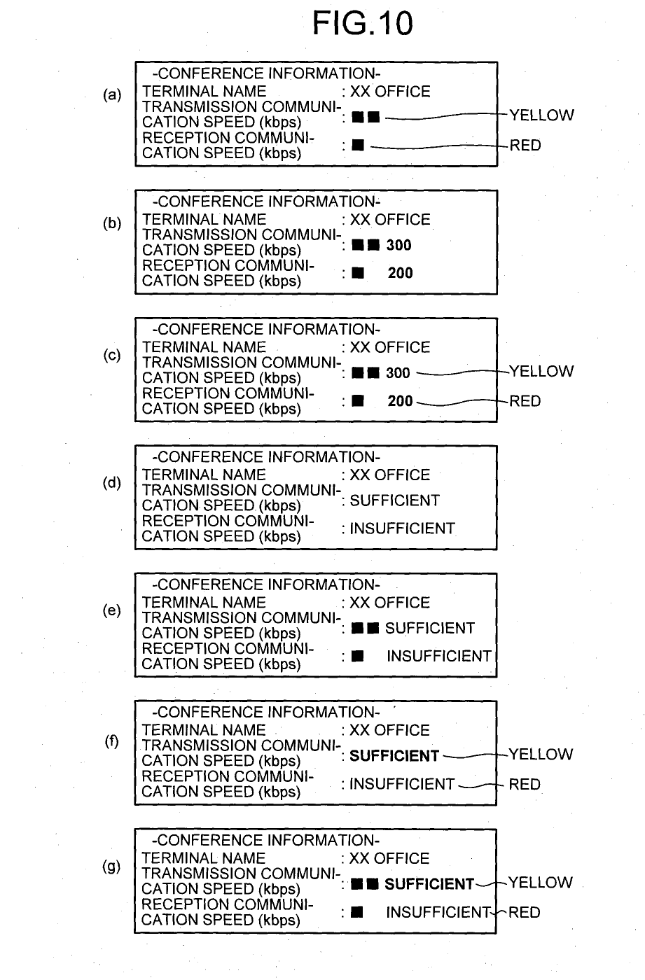

FIG. 10 illustrates various display examples other than the examples of (b) and (c) of FIG. 9. Illustrated in (a) of FIG. 10 is an example in which color distinction and the number of divisions are combined. Illustrated in (b) of FIG. 10 is an example in which the value of a communication speed is added to the number of divisions. Illustrated in (c) of FIG. 10 is an example in which the value of a communication speed is added in the example of (a) of FIG. 10. Illustrated in (d) of FIG. 10 is an example in which the state of a communication speed is displayed with characters (words) instead of color distinction or the number of divisions. Illustrated in (e) of FIG. 10 is an example in which characters and the number of divisions are combined. Illustrated in (f) of FIG. 10 is an example in which characters and color distinction are combined. Illustrated in (g) of FIG. 10 is an example in which characters and the number of divisions are combined.

### Second Embodiment

The first embodiment employs a method in which the state of an actual communication speed varying with time is displayed during communication. In the second embodiment, in addition to the display of the state of an actual communication speed (measured value) varying with time similarly to the first embodiment, a maximum value of the communication speed is detected in each given period (given time interval) and, regarding the maximum value as a virtual theoretical value, the state of the virtual theoretical value is also displayed.

Here, a maximum value of the communication speed obtained in each given period during communication can be regarded as a so-called maximum communication speed that is expected (available) in the given period. Thus, the maximum value of the communication speed in such a given period is regarded as a virtual theoretical value.

With the display of the state of an actual communication speed (measured value) varying with time and the state of a virtual theoretical value during communication, when the communication quality is poor in measured value and the communication quality is good in virtual theoretical value, for example, a user can assume that the communication quality is deteriorated temporarily and will be better soon.

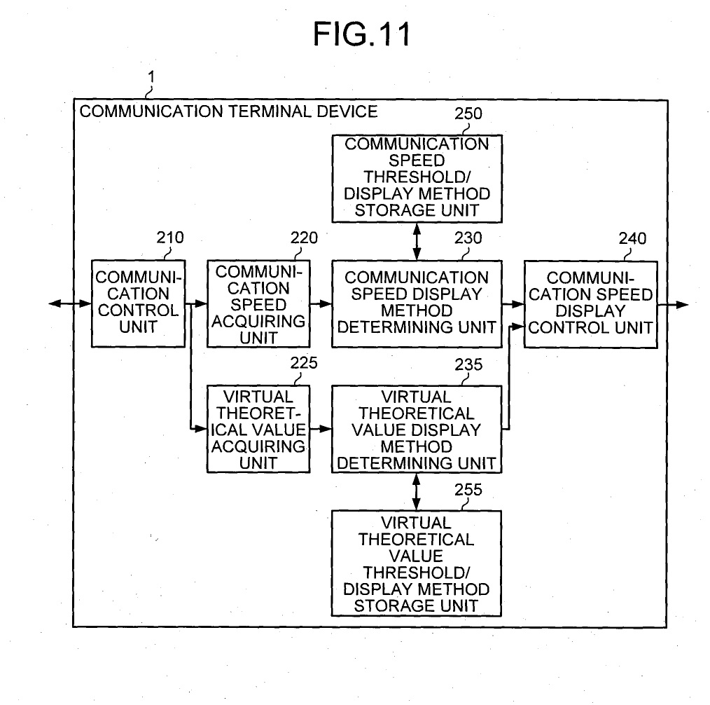

FIG. 11 is a function block diagram of a main configuration of the communication terminal device 1 according to the second embodiment. In FIG. 11, the communication control unit 210, the communication speed acquiring unit 220, the communication speed display method determining unit 230, the communication speed display control unit 240, and the communication speed threshold/display method storage unit (first storage unit) 250 are the same as in FIG. 4. A virtual theoretical value acquiring unit 225, a virtual theoretical value display method determining unit 235, and a virtual theoretical value threshold/display method storage unit (second storage unit) 255 are units that are added newly.

Similarly to the case of FIG. 4, the communication control unit 210 corresponds to the network I/F 111 in FIG. 3. The functions of the communication speed acquiring unit 220, the virtual theoretical value acquiring unit 225, the communication speed display method determining unit 230, the virtual theoretical value display method determining unit 235, and the communication speed display control unit 240 are achieved in cooperation with the CPU 101 and a given program stored in the ROM 102 or the flash memory 104 in FIG. 3. The communication speed threshold/display method storage unit 250 and the virtual theoretical value threshold/display method storage unit 255 correspond to a given storage area in the flash memory 104 in FIG. 3.

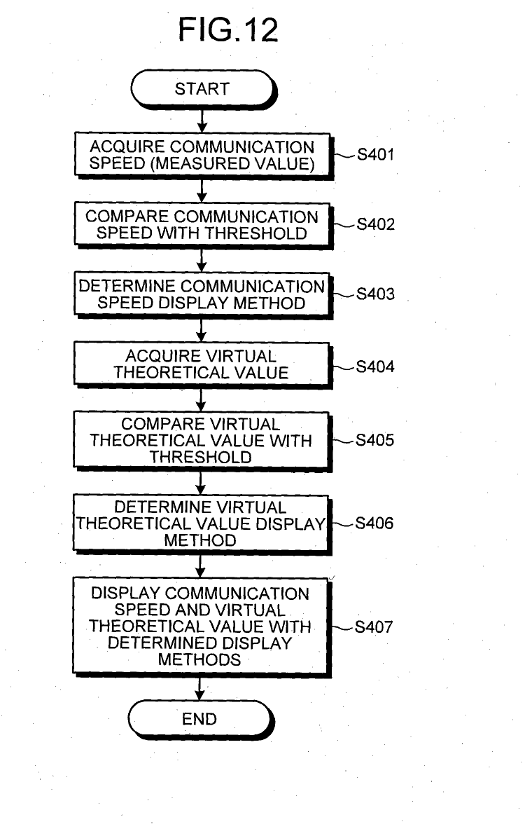

FIG. 12 illustrates a flowchart of the entire processing of the communication speed acquiring unit 220, the communication speed display method determining unit 230, the virtual theoretical value acquiring unit 225, the virtual theoretical value display method determining unit 235, and the communication speed display control unit 240 in FIG. 11. A program for performing the process flowchart is stored in the ROM 102 or the flash memory 104 in FIG. 3. The program may be recorded in a computer readable recording medium (external recording medium 106, etc.) for distribution.

FIG. 12 is also a diagram illustrating process steps of the communication state display method according to the second embodiment.

Similarly to the case of the first embodiment, while the communication terminal device 1 performs communication such as a video conference with another communication terminal device through a network, the communication speed acquiring unit 220 of the communication terminal device acquires an actual communication speed (measured value) of video, audio, etc. (Step S401). To be more specific, the communication speed acquiring unit 220 acquires, from the communication control unit 210 (concretely, the network I/F 111 in FIG. 3), communication speeds at which the communication terminal device 1 transmits video, audio, data, etc. to another communication terminal device, and sums these communication speeds to obtain a transmission communication speed. Similarly, the communication speed acquiring unit 220 acquires, from the communication control unit 210, communication speeds at which the communication terminal device 1 receives video, audio, data, etc. from another communication terminal device, and sums these communication speeds to obtain a reception communication speed. The communication speed acquiring unit 220 transmits the transmission communication speed and the reception communication speed to the communication speed display method determining unit 230.

Also in the second embodiment, when the communication control unit 210 controls the total transmission communication speed and reception communication speed of video, audio, data, etc., the communication speed acquiring unit 220 may acquire the total transmission communication speed and reception communication speed directly from the communication control unit 210.

During communication, the communication speed display method determining unit 230 compares the communication speed (transmission communication speed and reception communication speed) transmitted from the communication speed acquiring unit 220 with the thresholds for the communication speed in the communication speed threshold/display method storage unit 250 so as to determine which group the communication speed belongs to (Step S302) and determine a display method (first display method) for displaying the state of the communication speed during the communication (Step S303). Then, the communication speed display method determining unit 230 transmits the determined display method to the communication speed display control unit 240.

The communication speed threshold/display method storage unit 250 stores therein a threshold for the communication speed corresponding to the communication quality and a display method for displaying the state of the communication speed (first display method) for respective groups into which the communication quality in communication is preliminarily categorized.

The virtual theoretical value acquiring unit 225 also acquires actual communication speeds of video, audio, data, etc. from the communication control unit 210, and sums the actual communication speeds to obtain a communication speed. Regarding the communication speed, the virtual theoretical value acquiring unit 225 detects a maximum value of the communication speed in each given period (given time interval), and regards the maximum value as a virtual theoretical value (Step S404). In a period immediately after communication is stated, a predetermined maximum communication speed (a maximum communication speed that is expected theoretically when network environments are all prepared) is regarded as a virtual theoretical value.

The virtual theoretical value acquiring unit 225 acquires a virtual theoretical value for each of the transmission communication speed and the reception communication speed. Then, the virtual theoretical value acquiring unit 225 transmits the acquired virtual theoretical values (virtual theoretical value of transmission and virtual theoretical value of reception) to the virtual theoretical value display method determining unit 235.

The virtual theoretical value display method determining unit 235 compares the virtual theoretical value (virtual theoretical value of transmission and virtual theoretical value of reception) transmitted from the virtual theoretical value acquiring unit 225 with the thresholds for the virtual theoretical value in the virtual theoretical value threshold/display method storage unit 255 so as to determine which group the virtual theoretical value belongs to (Step S405) and determine a display method (second display method) for displaying the state of the virtual theoretical value (Step S406). Then, the virtual theoretical value display method determining unit 235 transmits the determined display method to the communication speed display control unit 240.

The virtual theoretical value threshold/display method storage unit 255 stores therein a threshold for the virtual theoretical value corresponding to the communication quality and a display method (second display method) for displaying the state of the virtual theoretical value for respective groups into which the communication quality in communication is preliminarily categorized. The virtual theoretical value threshold/display method storage unit 255 basically has the same configuration as the communication speed threshold/display method storage unit 250.

The communication speed display control unit 240 controls the display on the display 120 through the display I/F 117 in order to display the states of an actual communication speed during communication and a virtual theoretical value in accordance with the display methods transmitted from the communication speed display method determining unit 230 and the virtual theoretical value display method determining unit 235 (Step S407). The states of an actual communication speed and a virtual theoretical value are displayed regarding each of transmission and reception.

In the following, a concrete action example of the communication terminal device 1 according to the second embodiment of FIG. 11 is described. Here, the state of an actual communication speed during communication is displayed with the number of divisions, and the state of a virtual theoretical value is displayed in color distinction.

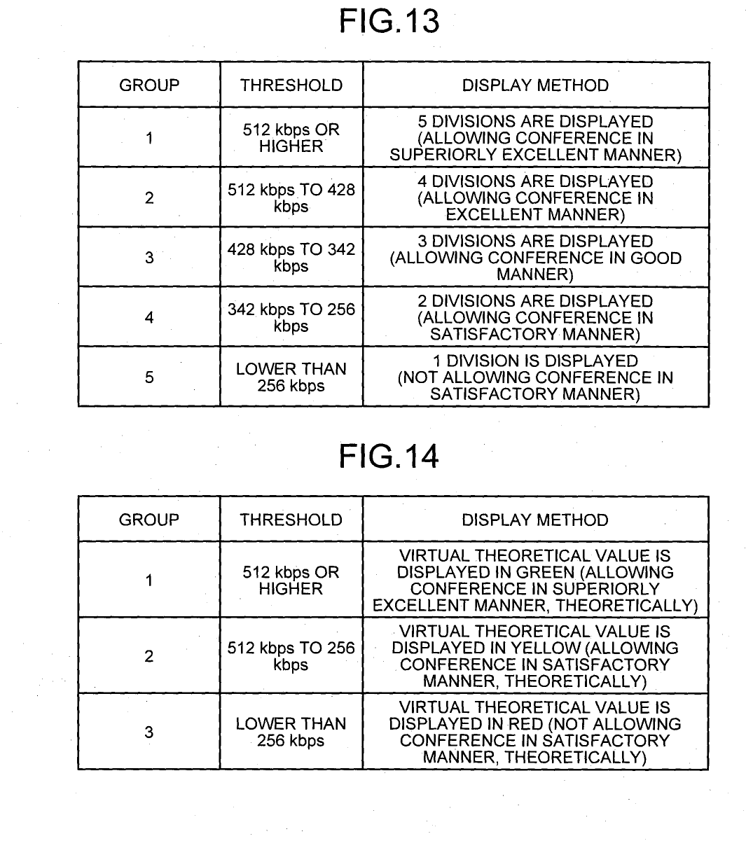

FIG. 13 is a diagram illustrating a concrete example of thresholds and display methods (first display methods) of the communication speed stored in the communication speed threshold/display method storage unit 250. In FIG. 13, similarly to the above described FIG. 8, the communication quality in communication is categorized into five groups, and the threshold for the communication speed is also categorized into five groups, so that the state of a communication speed of each group is distinguished using the number of divisions.

FIG. 14 is a diagram illustrating a concrete example of thresholds and display methods (second display methods) of the virtual theoretical value stored in the virtual theoretical value threshold/display method storage unit 255. In this case, the communication quality in communication is categorized into three groups, and the threshold for the virtual theoretical value is also categorized into three groups, so that the state of a virtual theoretical value of each group is distinguished using a different color. FIG. 14 is the same as the above described FIG. 7 if the virtual theoretical value is reworded as the communication speed.

In FIG. 13 and FIG. 14, the state of an actual communication speed is categorized into five groups, and the state of a virtual theoretical value is categorized into three groups. However, these are merely examples. For example, the state of a virtual theoretical value may be categorized into five groups, and the state of an actual communication speed may be categorized into three groups. Alternatively, the both states may be categorized into the same number of groups. Moreover, the thresholds do not need to be on the same basis.

Here, it is assumed that the communication speed acquiring unit 220 provides transmission communication speed of 550 kbps and reception communication speed of 200 kbps. It is assumed that the virtual theoretical value acquiring unit 225 provides transmission virtual theoretical value of 600 kbps and reception virtual theoretical value of 600 kbps as well.

Referring to the communication speed threshold/display method storage unit 250 (FIG. 13), the communication speed display method determining unit 230 determines that the transmission communication speed 550 kbps belongs to group 1 and the display method thereof is with five divisions. Similarly, the communication speed display method determining unit 230 determines that the reception communication speed 200 kbps belongs to group 5 and the display method thereof is with one division.

Referring to the virtual theoretical value threshold/display method storage unit 255 (FIG. 14), the virtual theoretical value display method determining unit 235 determines that the transmission virtual theoretical value 600 kbps belongs to group 1 and the display method thereof is in green. Similarly, the virtual theoretical value display method determining unit 235 determines that the reception virtual theoretical value 600 kbps also belongs to group 1 and the display method thereof is in green.

The communication speed display control unit 240 controls the display on the display 120 through the display I/F 117 in order to display the states of an actual communication speed and a virtual theoretical value in accordance with the display methods determined by the communication speed display method determining unit 230 and the virtual theoretical value display method determining unit 235.

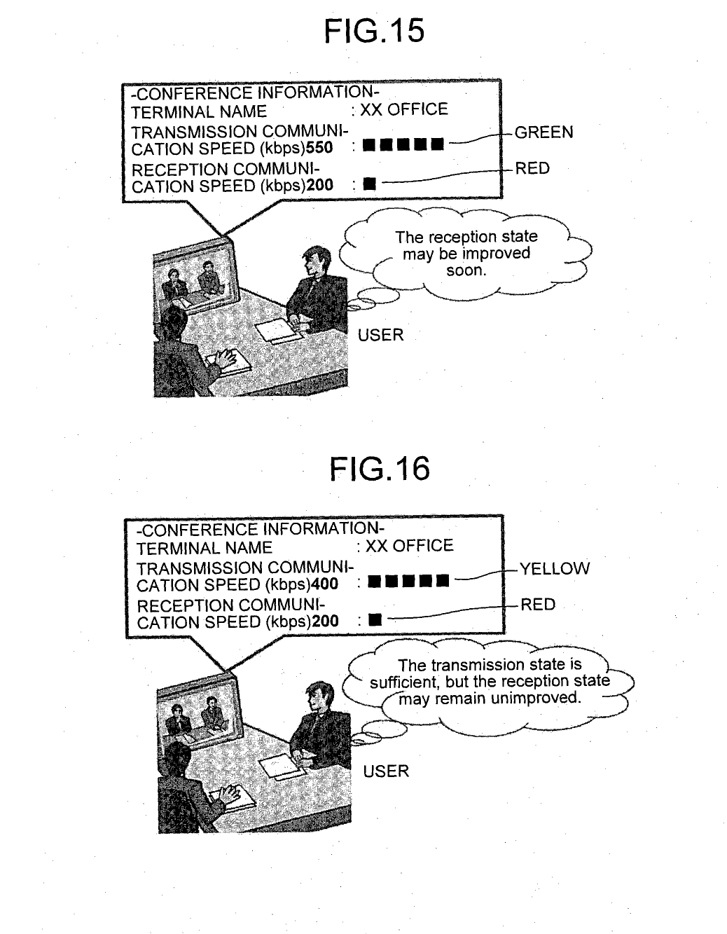

FIG. 15 is a diagram illustrating a display example on the display 120 in the above described example. That is, the state of transmission communication speed of 550 kbps is displayed with five divisions, and the state of reception communication speed is displayed with one division. The state of transmission virtual theoretical value of 600 kbps is displayed with five divisions of the transmission communication speed in green, and the state of reception virtual theoretical value of 600 kbps is displayed with one division of the reception communication speed in green. Thus, a user can instinctively understand, referring to the display in FIG. 15, that the reception state is deteriorated temporarily and may be improved soon, for example.

FIG. 16 is a diagram illustrating another display example on the display 120. This is an example of a case where an actual transmission communication speed is 400 kbps and an actual reception communication speed is 200 kbps and, regarding the virtual theoretical value, a virtual theoretical value of transmission is 450 kbps and a virtual theoretical value of reception is 220 kbps, for example. A user can instinctively understand, referring to the display in FIG. 16, that the transmission state allows him or her to hold a conference in a satisfactory manner and the reception state may remain unimproved for a while, for example.

In FIG. 15 and FIG. 16, the states of actual transmission and reception communication speeds are displayed with the number of divisions, and the states of virtual theoretical values of transmission and reception are displayed by color distinction. Conversely, the states of actual transmission and reception communication speeds may be displayed by color distinction, and the states of virtual theoretical values of transmission and reception may be displayed with the number of divisions. Alternatively, the values of transmission and reception communication speeds may be displayed by color distinction. In short, any method can be employed as the display method as long as a user can recognize at a glance the states of actual transmission and reception communication speeds and the states of transmission and reception virtual theoretical values.

The embodiments have been described based on the enclosed drawings. It will be understood that the invention is not limited to the embodiments described with reference to the drawings. Moreover, the communication speed can be reworded as the communication band (bandwidth) in the above description. That is, the communication speed includes the communication band (communication bandwidth in transmission and reception of video, audio, etc.).

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A communication terminal device that performs communication with another communication terminal device through a network, the communication terminal device comprising:
a storage unit configured to store therein thresholds for communication speed and display methods for displaying states of the communication speed for respective groups into which communication quality is categorized;
an acquiring unit configured to acquire a communication speed during communication;
a determining unit configured to compare the acquired communication speed with the thresholds for the communication speed stored in the storage unit and determine a display method for displaying a state of the acquired communication speed; and
a display unit configured to display the state of the acquired communication speed with the determined display method.

2. The communication terminal device according to claim 1, wherein the display methods include displaying the communication speed with a different color for each of the groups.

3. The communication terminal device according to claim 1, wherein the display methods include displaying the communication speed with a different number of divisions for each of the groups.

4. The communication terminal device according to claim 1, wherein the display methods includes displaying the communication speed with a different word for each of the groups.

5. The communication terminal device according to claim 1, wherein the display methods include displaying the communication speed with at least two of a different color for each of the groups, a different number of divisions for each of the groups, and a different word for each of the groups.

6. A communication terminal device that performs communication with another communication terminal device through a network, the communication terminal device comprising:
a first storage unit configured to store therein thresholds for communication speed and first display methods for displaying states of the communication speed for respective groups into which communication quality is categorized;
a second storage unit configured to store therein thresholds for virtual theoretical value of communication speed and second display methods for displaying states of the virtual theoretical value for respective groups into which communication quality is categorized;
a communication speed acquiring unit configured to acquire a communication speed during communication;
a first determining unit configured to compare the acquired communication speed with the thresholds for the communication speed stored in the first storage unit and determine a first display method for displaying a state of the acquired communication speed;
a maximum value acquiring unit configured to acquire, in each given period of the communication, a maximum value of the communication speed in the period as a virtual theoretical value;
a second determining unit configured to compare the acquired virtual theoretical value with the thresholds for the virtual theoretical value stored in the second storage unit and determine a second display method for displaying a state of the acquired virtual theoretical value; and
a display unit configured to display the state of the acquired communication speed by the determined first display method and display the state of the acquired virtual theoretical value by the determined second display method.

7. A communication system comprising a plurality of communication terminal devices, each corresponding to the communication terminal device according to claim 1, the communication terminal devices being connected through the network.

8. A method for displaying a communication state in a communication terminal device that performs communication with another communication terminal device through a network, the communication terminal device including a storage unit configured to store therein thresholds for communication speed and display methods for displaying states of the communication speed for respective groups into which communication quality is categorized, the method comprising:
acquiring a communication speed during communication;
comparing the acquired communication speed with the thresholds for the communication speed stored in the storage unit;
determining a display method for displaying a state of the acquired communication speed; and
displaying the state of the acquired communication speed with the determined display method.

9. A non-transitory computer-readable recording medium with an executable program stored thereon, wherein the program instructs a computer to perform the method according to claim 8.
